(19) United States
(12) Patent Application Publication
(10) Pub. No.: US 2007/0168235 A1
(43) Pub. Date: Jul. 19, 2007

(54) PROVISION OF FINANCIAL BENEFITS ASSOCIATED WITH INVESTMENT PRODUCTS

(75) Inventors: James L. Livingston, Centennial, CO (US); Steven M. Kluever, Castle Rock, CO (US); Clifford J. Jack, Denver, CO (US)

Correspondence Address: BANNER & WITCOFF, LTD., 1100 13th STREET, N.W., SUITE 1200, WASHINGTON, DC, 20005-4051, US

(73) Assignee: Jackson National Life Insurance Company, Lansing, MI (US)

(21) Appl. No.: 11/622,267

(22) Filed: Jan. 11, 2007

Related U.S. Application Data
(60) Provisional application No. 60/758,810, filed on Jan. 13, 2006.
(60) Provisional application No. 60/772,460, filed on Feb. 10, 2006.

(51) Int. Cl. G06Q 40/00

(52) U.S. Cl. 705/4

(57) ABSTRACT

A variable annuity or other investment vehicle may be offered that invests in a single public mutual fund to allow an investor to be taxed on a non-deferred capital gains basis as opposed to a tax-deferred income basis. Additionally or alternatively, an insurance policy may be wrapped around, or otherwise associated with, the variable annuity or other investment vehicle.

### RELATED APPLICATIONS

The present application claims priority to U.S. Provisional Application Ser. No. 60/758,810, filed Jan. 13, 2006, entitled “Systems, Methods, and Computer Program Products for Mutual Funds Associated With Guaranteed Benefits,” and also to U.S. Provisional Application Ser. No. 60/772,460, filed Feb. 10, 2006, entitled, “Systems, Methods, and Computer Program Products for Living Benefits Associated With Investment Products and/or Vehicles,” each of which is hereby incorporated by reference in its entirety.

### BACKGROUND

An annuity is a financial product that can provide a periodic distribution for a fixed period of time or for a non-fixed period of time that depends upon the lifetime of the annuity holder. These types of products have both an investment aspect and an insurance aspect and are useful for those investors wishing to reduce the risk that they will outlive their savings. However, some investors shy away from annuities because they are perceived as complex and expensive and because they may not provide the most desirable federal income taxation. For instance, distributions from non-qualified annuities in the deferral stage are typically treated as gains being distributed first and principal distributed last. Distributions of gains from annuities are typically taxed as ordinary income, whereas distributions of long term capital gains and qualifying dividends from other types of investments, such as stocks and mutual funds, are typically taxed at lower preferential rates.

Mutual funds are another type of popular financial product. These types of products can also provide some level of security against loss of investment because they usually invest in a large number and variety of stocks and/or bonds, thereby diluting the risks associated with individual stocks and bonds. An equity-based mutual fund can mitigate the risk of an individual stock performing poorly, but cannot typically mitigate the risk of the overall market or a targeted sector performing poorly. Mutual funds can provide a tax advantage in that distributions from mutual funds are often subject to the lower preferential tax rates applicable to qualifying dividends and long term capital gains. A problem with mutual funds and other non-guaranteed investment products is the risk of losing substantial investment value. In general, risk is closely tied to expected gains. Accordingly, many investors also shy away from many types of mutual funds and other investments having inherent risk, particularly as they near retirement, and after retirement.

Still another type of financial product is one that invests in mutual funds or other risk-type investments yet provides protection of initial investment principal. These products, commonly called Principal Protected Funds, mitigate market risk by investing in a mix of equities and fixed income instruments, and changing that mix to nearly 100% short term fixed income investments as the principal guarantee date approaches, in any market where there is a risk of failing to fund the guarantee. These products are insured on a group, or fund, level—at a predetermined date certain, the aggregate investment value for the universe of investors in that product is guaranteed to be at least the original group investment amount. Historically equity investments have provided higher returns, (and more risk or volatility of returns) than fixed income investments. The problem with Principal Protected funds has been that they often evolve into fixed income funds as they approach the guaranteed return date, but they have management charges much higher than a typical fixed income fund. The investor loses the opportunity for equity returns and pays a relatively high management expense.

To the knowledge of the inventors, nobody has offered a financial product that provides insurance or other guarantee, at an individual investor level, on a separately owned, publicly available, risk-type investment such as a mutual fund. Even more so, it appears that nobody has provided such a product that likely allows the investor to enjoy the preferential tax treatment on the distribution of qualifying dividends and long term capital gains, commonly available on such separately owned investments.

### SUMMARY

As will be discussed in further detail, a first financial entity (e.g., an insurance company), and possibly also a second financial entity (e.g., an investment company) may provide services to customers by tying certain benefits to investment products.

For instance, a group contract (such as a group variable annuity contract) may be offered by the first financial entity to the second financial entity that offers an investment product. Thus, the second financial entity may be the group contract owner. Then, a customer of the second financial entity may invest in the investment product offered by the second financial entity, such that the customer becomes a shareholder in the investment product. As referenced by the group contract, the first financial entity may issue a certificate to the customer entitling the customer to one or more financial benefits relating to the value of the investment. In return, the first financial entity may receive one or more payments from the second financial entity and/or the customer.

As another example, an individual contract may be offered by the first financial entity to each of a plurality of investors. A second financial entity may or may not be involved. Each investor may purchase an investment (such as a variable annuity) through the first financial entity or the second financial entity, and the contract for each investor may provide for the first financial entity (or some other delegated entity) to insure that individual investor's investment (as opposed to group-level aggregate value insurance as described in the Background section). In this way, any type of investment may be insured or otherwise guaranteed by establishing an insurance policy on an investment account for an individual. Where the same financial entity provides both the investment product and the guarantee on the investment product, the investor may be provided with the convenience of one-stop shopping in pursuit of multiple objectives—taking on a certain amount of financial risk in exchange for potentially higher returns while also mitigating that risk through insurance. Also, as opposed to group-level principal-protected mutual-fund products, the total amount paid to the individual under the insurance policy and the investment account may not be limited to the total amount paid by the individual into the investment account, if such a situation is desired.

In both situations (the group contract and the individual contract), the investor may be placed in a desirable tax position depending upon how the contract and/or investment is arranged. For instance, where the investor invests in a single public mutual fund, the investor may be considered the owner of the mutual fund investment even though the first financial entity may hold the mutual fund shares for the investor. This may result in the investor being taxed on the investment on the basis of dividends and capital gains on the investment, and withdrawals from the investment, as opposed to being taxed on an income basis.

These combined product features may create significant advantages for both financial advisors and investors. The target market may be financial advisors who primarily sell mutual funds to clients who are seeking to invest qualified and non-qualified money and want some level of protection from market and longevity risks. The product therefore may be targeted at financial advisors that have not traditionally sold variable annuities but have clients that could benefit from a guaranteed lifetime income as well as protection from excessive market risks. That target financial advisors may include, for example, traditional load brokers. This may appeal to a broad range of advisers and help separate the product from the rest of the market that competes with traditional investment vehicles.

The above-mentioned financial benefits may include, for example, one or more guaranteed living benefits, including guaranteed minimum redemption benefits (GMRB), provided by the first financial entity. The investment products offered by the second financial entity may include, but are not limited to, mutual funds, exchange traded funds (ETFs), stocks, hedge funds, unit investment trusts (UITs), unified managed accounts (UNMAs), closed-end funds, other investment pools, variable annuities, brokerage accounts, retirement savings vehicles (e.g., 401(K)s, 403(b)s, IRAs, etc.), educational savings plans (e.g., education savings accounts, 529 plans, etc.), mutual fund wrap programs (e.g., mutual fund wrap fee account), and separately managed accounts (SMAs), which may include model-managed multi-disciplined accounts such as those offered by Curian Capital. These investment products may or may not generally derive a daily asset value based upon market performance. For example, mutual funds are priced daily based upon a net asset value determination. Likewise, stocks and ETFs are traded and priced on an exchange throughout a trading day. Of course, one of ordinary skill in the art will recognize that other investment products may derive an asset value on a periodic, but perhaps less than daily, basis.

As previously discussed, the guaranteed minimum redemption benefit associated with the value of the investment product may be provided by the first financial entity, such as an insurance company. The investment product, such as mutual fund shares, ETFs, or hedge funds, may be purchased by shareholders via a second financial entity, which may be a principal underwriter, broker-dealer, and the like. Any purchased investment shares would then be issued to the shareholders by the mutual fund(s), exchange traded fund(s), and/or hedge fund(s) themselves. One of ordinary skill will recognize that all or perhaps only a portion of the value of the investment shares may be tied to or linked with the guaranteed benefits, including the guaranteed minimum redemption benefits (GMRB). One of ordinary skill in the art will also recognize that other investment products as described above can be utilized instead of or in addition to the mutual funds, ETFs, and hedge funds described above. Likewise, while the examples described herein refer to mutual funds, other examples may include other investment products described above, including ETFs and hedge funds, instead of or in addition to the mutual funds.

In the case of mutual funds, for example, the GMRB associated with the value of the mutual fund shares may be provided by the first financial entity (e.g., insurance company) under a group contract held by the second financial entity (e.g., mutual fund's advisor, principal underwriter, broker-dealer, etc.) or an individual contract between the first financial entity and the investor. In the case of the group contract, the second financial entity may obtain a group variable annuity contract from the first financial entity, where the group variable annuity contract is tied to at least a portion of the value of the mutual fund shares. The first financial entity can then issue one or more written (e.g., electronically stored on one or more computer-readable media and/or printed on paper or another physical medium) certificates under the group variable annuity contract to the mutual fund shareholders electing or requesting the GMRB. In an exemplary embodiment of the present invention, the mutual fund's advisor or principal underwriter can be the owner or holder of the contract and the mutual fund shareholders who elect the GMRB would be the participants or certificate holders under the contract.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 is a functional block diagram of an illustrative relationship between various parties to an agreement involving at least one investment product and a guaranty of at least a portion of the value of the investment product.

FIG. 2 is a functional block diagram of another illustrative relationship between various parties to an agreement involving at least one investment product and a guaranty of at least a portion of the value of the investment product.

FIG. 3 is a functional block diagram of yet another illustrative relationship between various parties to an agreement involving at least one investment product and a guaranty of at least a portion of the value of the investment product.

FIG. 4 is a diagram of an illustrative environment that may be used to implement various aspects described herein.

### DETAILED DESCRIPTION

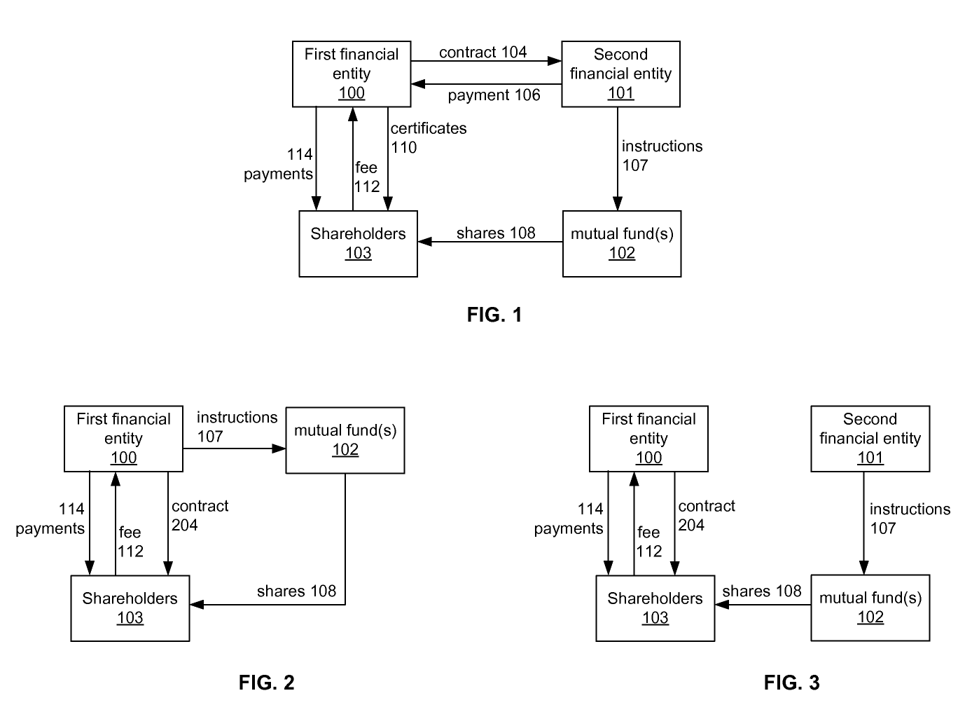

An exemplary implementation of the group variable annuity contract and the certificates issued under the group variable annuity contract will now be described in further detail below with reference to FIG. 1.

### Group Contract

Referring to the example of FIG. 1, a group variable annuity contract 104 is issued by a first financial entity 100, which may be an insurance company, and held or owned by a second financial entity 101, which may be the mutual fund's advisor, principal underwriter, or broker-dealer that provides one or more shares 108 to one or more mutual fund shareholders 103. More specifically, as shown in FIG. 1, the first financial entity 100 provides the group variable annuity contract 104 to the second financial entity 101, and in return the second financial entity 101 provides a payment, such as a purchase payment or deposit 106, to the first financial entity 100. Specifications of an example of group variable annuity contract 104 are described in Exhibit A attached hereto. The entirety of Exhibit A is incorporated into and part of the present specification.

The amount of the purchase payment or deposit 106 may be based on a cash value or accumulation value for the group variable annuity contract 104 that is available to the second financial entity 101. Because this cash value or accumulation value is associated with purchase payments or deposits 106 actually held by the first financial entity 100, the cash value or accumulation value may be considered to be a “non-synthetic” component of the group variable annuity contract 104. The purchase payments or deposits 106 may be allocated to one or both of a fixed account or separate account of the first financial entity 100. Under the fixed account, the second financial entity 101 can allocate the purchase payments or deposits 106, or a portion thereof, to an account that provides, for example, a guaranteed interest rate. Under the separate account, the second financial entity 101 can allocate the purchase payments or deposits 106, or a portion thereof, into one or more mutual funds such as one or more publicly-available mutual funds. The value of any amounts allocated to the separate account would thus vary with the market performance of the selected mutual funds. One of ordinary skill in the art will recognize that other investment products can be utilized instead of or in addition to these mutual funds.

In addition to the non-synthetic component, the group variable annuity contract 104 may also include a synthetic component. This synthetic component arises because, in this example, the group variable annuity contract 104 issued by the first financial entity 100 provides for a guaranteed benefit such as a GMRB that is tied or otherwise linked to the value of the mutual fund shares 108, even though the shares 108 are not owned or held by the first financial entity 100. The shareholders 103 may purchase the mutual fund shares 108 from the second financial entity 101, which in turn directs 107 the mutual fund(s) 102 to issue the shares 108 to the shareholders 103. One of ordinary skill in the art will recognize that the mutual fund shares 108 purchased by the shareholder 103 may be held by the second financial entity 101 for the benefit of the shareholder 103. Because the mutual fund shares 108 are not actually held as assets by the first financial entity 100 under its issued group variable annuity contract 104, this guaranteed benefit, such as the GMRB, that is tied or otherwise linked to the mutual fund share 108 value, is considered a “synthetic” component of the group variable annuity contract 104. The value of the GMRB provided by the group annuity contract 104 to the mutual fund shareholders 103 may be independent of the cash or accumulation value of the variable annuity contract 104 available to the second financial entity 101.

One of ordinary skill in the art will readily recognize that a guaranteed investment contract (GIC) may be utilized in addition or in the alternative to the group variable annuity contract, and still other variations will also be readily apparent to one of ordinary skill in the art.

### Certificates Issued Under the Group Contract

Still referring to FIG. 1, the first financial entity 100 (e.g., an insurance company) can issue one or more certificates 110 to the mutual fund shareholders 103 (also referred to as certificate holders) electing the GMRB under the group variable annuity contract 104 for the shareholder's 103 mutual fund value. In other words, the certificates 110 may be issued to the mutual fund shareholders 103 by the first financial entity 100 under the group variable annuity contract 104 held at the second financial entity 101. Specifications of two examples of certificate 110 are described in Exhibit B attached hereto. The entirety of Exhibit B is incorporated into and part of the present specification.

In accordance with these certificates 110 issued under the group variable annuity contract 104, the mutual fund shareholders 103 may be assessed a risk fee or premium 112, such as on a periodic basis (e.g., quarterly), from the first financial entity 100 that issued the group variable annuity contract 104. The risk fee or premium 112 may be paid directly to the first financial entity 100 by the shareholder 103. In addition or in the alternative, a portion of the mutual fund shares 108 may automatically be redeemed as necessary to satisfy the risk fee or premium 112. The risk fee or premium 112 may be assessed as a percentage or other portion of the value of the mutual fund shares 108. For example, the risk fee or premium 112 may range generally from 30 to 100 basis points on an annualized basis. One of ordinary skill in the art will recognize that the risk fee or premium 112 may vary with a variety of factors, including one or more of the level of guaranteed benefits, payout losses, administrative costs, market performance of the mutual fund shares 108, bond yields, and the like. Alternatively, the risk fee or premium 112 may be assessed as a percentage or other portion of a guaranteed redemption benefit (GRB), which is described in more detail below. One of ordinary skill in the art will recognize that the risk fee or premium 112 may also vary across different investment products.

In addition, the risk fee or premium 112 for retirement savings accounts or educational savings accounts may be arranged such that a taxable or other penalizing event does not occur due to payment of the risk fee or premium 112. For example, the risk fee or premium 112 may be paid from funds held outside of any tax-deferred investment product (such as a retirement savings account or an educational savings account) in which the investments are made. Alternatively, the risk fee or premium 112 may be deferred, for instance as an offset of the amount eligible for withdrawal from the tax-deferred investment product.

In exchange for this risk fee or premium 112, however, the first financial entity 100, in accordance with certificates 110 issued under the group variable annuity contract 104, may pay the mutual fund shareholders 103 the amount of the GMRB each period to the extent that there is a remaining total GRB, once all of the mutual fund shares 108 have been redeemed or withdrawn. In other words, if mutual fund share 108 redemption or withdrawal, within a specified limit each period (e.g., each year), reduces the value of the mutual fund shares 108 to zero (i.e., there are no mutual fund shares 108 remaining), but there is still a GRB remaining, then as a result the first financial entity 100 will make payments 114 to the shareholder 103 each period until the remaining GRB amount is depleted.

A shareholder 103 may elect a particular GMRB, such as a 5% GMRB. At the time of election of the GMRB, the GRB may be equal to the value of the mutual fund shares 108. Or, the GRB may be equal to the purchase price of the mutual fund shares 108, including any acquisition fees such as front-end load fees. This GRB represents the minimum total amount that will be paid out under the GMRB. In addition, a guaranteed annual redemption amount (GARA) may be based upon the GRB, such as 5% of the GRB. This means that the shareholders 103 may be allowed to withdraw up to the GARA each year, where the amount of the withdrawal is funded by redeeming the necessary number of mutual fund shares 108. Any withdrawals made by the shareholders 103 would reduce their GRB accordingly. If all of the mutual fund shares 108 have been redeemed (e.g., the mutual fund balance is zero) and the GRB has not been exceeded, then as a result the first financial entity 100 would make direct payments 114 to the mutual fund shareholder 103 up to the GARA each year until the GRB has been depleted. In this way, the mutual fund shareholder 103 is guaranteed to receive at least the GARA each year up to the GRB. Once the GRB has been depleted, the first financial entity 100 would have no further payment obligations to the mutual fund shareholder 103.

Moreover, the GMRB as described above may be provided with a step-up provision. With the step-up provision, the current GRB and GARA can be adjusted upwards periodically, such as annually, for a certain number of years. In particular, the current GRB may be increased if the value of the mutual fund shares has increased beyond the previously-determined GRB. If the current GRB is stepped up, the new GARA may be calculated as a portion or percentage of the new GRB, such as 5% of the new GRB. In most if not all cases, the new GRB or GARA would not be lower than the previously-determined GRB and GARA. In addition, such a step-up may be provided automatically for a predetermined number of years or other predetermined period of time without a change in the risk fee or premium 112. Alternatively, the risk fee or premium 112 assessed by the first financial entity 100 may be increased in response to the shareholder electing the step-up provision. For example, the risk fee or premium 112 may be increased up to 200 basis points on an annualized basis to cover the election of the step-up provision. One of ordinary skill in the art will recognize that this risk fee or premium 112 may be freely adjusted.

As another example, the GMRB as described above may be provided with a bonus provision. Under the bonus provision, if the shareholder 103 is eligible to make a withdrawal under the GMRB, but declines to do so, then as a result the GRB may be increased by a calculated amount. This increased amount may be calculated based on a bonus base, such as 5% of the bonus base. The bonus base, in turn, may equal the GRB at the time of election of the GMRB. However, this bonus base may be adjusted based upon the step-up provision described above and/or based upon withdrawals.

It may be desirable that the mutual fund shareholder 103 be permitted to redeem shares 108 that exceed the allowable GARA. In this situation, the new GRB and the GARA may be reduced accordingly by the amount exceeding the allowable GARA. Alternatively, the new GRB and the GARA may be reduced in proportion to the reduction in the value of the mutual fund shares 108. Further, the mutual fund(s) may assess a surrender charge or other fee for redemptions or withdrawals. This surrender charge or other fee may be satisfied by automatically redeeming a portion of the shareholder's 103 mutual fund shares. While the above discussion has been with respect to an initial purchase of mutual fund shares, additional mutual fund shares may be subsequently purchased, and the above discussion may apply to these additional mutual fund shares.

In addition, a life guarantee may adjust the GMRB described above. The life guarantee may become effective once the certificate 110 holder achieves a certain age, such as 65 years of age. Once the life guarantee becomes effective, the GARA may be reset to a particular percentage (e.g., 5%) of the current GRB. The life guarantee may then terminate upon the death of the certificate 110 holder.

One of ordinary skill in the art will recognize that in addition or in the alternative to the GMRBs described above, other guaranteed living benefits may be provided. These living benefits may generally provide certificate 110 holders with current protection of principal, income, or the ability to take withdrawals, while they are still alive. For example, in addition to the GMRBs, these living benefits may include guaranteed minimum account benefits, guaranteed minimum income benefits, and guaranteed minimum accumulation benefits. One of ordinary skill in the art will recognize that guaranteed minimum death benefits or earnings protection benefits may be provided in addition or in the alternative to these guaranteed living benefits. Many other variations will be readily known to one of ordinary skill in the art.

Still further, all or a portion of the value of the mutual fund shares 108 may be annuitized. In order to provide such an annuity, at least a portion of the mutual fund shares 108 would be redeemed, thereby terminating any of the guaranteed benefits, including the GMRB, previously associated with the redeemed mutual fund shares 108. The proceeds of the redeemed mutual fund shares 108 would then be used by the mutual fund shareholder 103 to purchase the annuity from the first financial entity 100. The terms of the annuity may be governed by the certificate 110 issued under the group variable annuity contract 104 described above. The annuity may be one or more of a life income annuity, a joint and survivor annuity, a life annuity with a predetermined number of guaranteed periods (e.g., 120 or 240 monthly periods), and an income annuity for a specified period (e.g., 5 to 30 years).

The determination of the total benefits for a particular mutual fund shareholder 103 may involve combining the value of the annuity and the value of the mutual fund shares associated with the guaranteed benefits, including the GMRB. The total benefits may be presented as a lump sum or cash surrender amount, an annual benefit amount, or a combination thereof. Moreover, because there may be several income dates for the annuity and mutual fund shares subject to the GMRB, there may be different annual benefit amounts for different periods of time.

### Individual Contracts

Although the previous examples have been discussed in connection with issuing a certificate, a certificate may not be issued at all. In such a case, the shareholder 103 may purchase the shares 108 (or another investment) from the first financial entity 100 or the second financial entity 101, and the first financial entity 100 may provide benefits related to those shares 108. Referring to FIGS. 2 and 3, instead of the group contract 104, a contract 204 (which may be a written contract) may be made directly between first financial entity 100 and the shareholder 103. The contract 204 may specify, for example, the type(s) and terms of the financial investment to be made by the shareholder 103, as well as any living benefits, guarantees, and/or other benefits provided to the shareholder 103 by the first financial entity 100. The benefits and requirements defined by the contract 204 may include any one or more of the benefits and requirements as described previously, such as but not limited to a GMRB, GRB, and/or GARA, in any combination or subcombination.

The investment made by the shareholder 103 may be limited by the contract 204 to be a certain type of investment, such as one or more publicly-available mutual funds, i.e., mutual funds that may be purchased by the general public on a stand-alone basis from a mutual fund provider (such as the second financial entity 101) without a need for the relationship described herein between the first entity 100 and the shareholder 103. For example, the investment may be limited to a single publicly-available mutual fund or other single investment for the lifetime of the investment and/or contract. The shareholder 103 may purchase the mutual funds and/or other investment from the first financial entity 100 (FIG. 2) or from the second financial entity 101 (FIG. 3). In both the individual contract example here and in the group contract example described previously, the investment may be purchasable separately from any of the guarantees described herein (i.e., such investments may be publicly available).

The contract 204 between the first financial entity 100 and the shareholder 103 may define, for example, a taxable variable annuity (TVA) product in which the shareholder 103 pays periodic premiums, or a single premium, in exchange for annuitized payouts, living benefits, death benefits, and/or any other types of benefits. Such a TVA, which may define a separate account and optionally also a fixed account, may be similar to traditional variable annuities from an insurance perspective. A difference may be, however, that the separate account of the TVA invests in publicly available mutual funds rather than funds available only through insurance company separate accounts.

This difference may result in various tax implications that could be advantageous to the shareholder 103. For instance, where the investment is limited to a single publicly-available mutual fund, it is likely that the shareholder 103 would be taxed in the same way as they would otherwise be had they directly owned the mutual funds outside of the separate account on a stand-alone basis. In other words, the shareholder may be considered the direct owner of the mutual fund or other investment and taxed on the basis of dividends and capital gains on the investment, and withdrawals from the investment, as opposed to being taxed on an income basis. This is in contrast to traditional variable annuities, in which investment growth is tax-deferred until withdrawal and taxed as ordinary income.

In addition, the contract 204 may allow for non-spouse beneficiaries to elect to receive any death benefit that is payable under the contract over payment terms that exceed the maximum payment terms permitted under Internal Revenue Code § 72(s). The contract 204 may further define various share classes of investments that provide different amounts of risk and reward, as well as differing benefits as desired.

Once a particular mutual fund is purchased through the contract, the contract may prevent the investor from exchanging mutual funds and/or re-allocating the investment among a different mutual fund or funds. This may be a pre-requisite for realizing the tax benefits described above. If the shareholder 103 chooses to redeem shares of his or her investment to pay for the cost of any benefits, the shareholder 103 may be immediately taxed on the share redemption. Benefits “in the money” may not be taxable to the shareholder 103 until payments are made by the first financial entity 100, rather than designated investments (e.g., mutual funds). In addition, the shareholder 103 may not be able to “wash” capital losses from the investment with ordinary income from the variable annuity or other type of contract 104. Instead, the shareholder 103 may be taxed at ordinary income tax rates for any benefit payments (i.e., those not taken from the investment) made by the first financial entity 100 under the contract 204.

Thus, in the examples shown in FIGS. 2 and 3, the contract 204 may be considered an insurance contract between the first financial entity 100 and the shareholder 103. Similar to the certificate 110 of FIG. 1, the contract 204 insures the variable annuity (or other investment product). The insurance benefits provided may be similar or even identical to those previously described in connection with FIG. 1. For instance, if mutual fund share 108 redemption or withdrawal, within a specified limit each period (e.g., each year), reduces the value of the mutual fund shares 108 to zero (i.e., there are no mutual fund shares 108 remaining), but there is still a GRB remaining, then as a result the first financial entity 100 will make payments 114 under the contract 204 to the shareholder 103 each period until the remaining GRB amount is depleted.

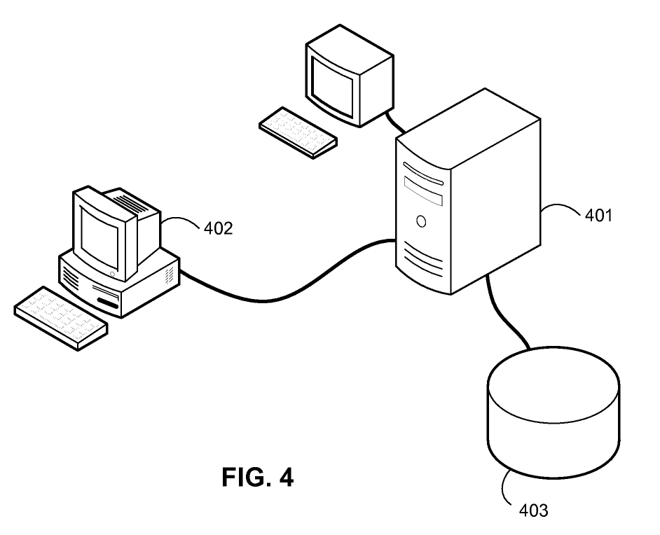

The above-described features of the investment product, the group contract, various payments, and/or the living benefits may be tracked, calculated, and otherwise implemented using one or more computers. For instance, referring to FIG. 4, a server 401 and associated terminal may be coupled to a personal computer 402 via a signal connection. The server 401 and/or the personal computer 402 may further be coupled to a storage unit 403 having one or more computer-readable media (such as a hard disk drive). The storage unit 403 which may be physically separate from or integrated with the server 401 and/or the personal computer 402. The server 401, the personal computer 402, and/or the storage unit 403 may be located at, used by, and/or under the control of, the first financial entity 100 and/or the second financial entity 101.

The server 401 and/or the personal computer 402 may execute software, in the form of computer-executable instructions. The software may be stored on, for example, the computer-readable media of the storage unit 403. The storage unit 403 may also store various data such the text and any other content of the group contract 104 (e.g., the various provisions of the group contract 104), and/or the text and any other content of the certificate 110, in a computer-readable code (such as a in a word-processing file). The text may be printed onto paper using a printer (not shown) coupled to the server 401 and/or the personal computer 402 to provide a written version of the contract 104 and/or the certificate 110. In addition, the stored software may cause the server 401 and/or the personal computer 402 to keep track of the investment assets, fees, payments, obligations (e.g., living benefits) and/or any other status or properties of the relationship between the various parties 100, 101, 103, and other properties of each annuity.

The shown set of computers in FIG. 4 is merely illustrative; any number and type of computers may be used. In addition, the connection between the server 401 and the personal computer 402 may be a direct connection such as a cable or a network such as a local area network and/or the Internet. Where the connection is a network, the server 401 and the personal computer 402 may be at geographically different locations, even in different countries.

The mutual funds described above are for illustrative purposes only and are merely one type of investment product that may be utilized. Indeed, as described above, these other investment products may include, but are not limited to, exchange traded funds (ETFs), stocks, hedge funds, unit investment trusts (UITs), unified managed accounts (UNMA's), closed-end funds, other investment pools, variable annuities, brokerage accounts, retirement savings vehicles (e.g., 401(K)s, 403(b)s, IRAs, etc.), educational savings plans (e.g., education savings accounts, 529 plans, etc.), and separately managed accounts (SMAs) such as those offered by Curian Capital. Many modifications and other examples will come to mind to one skilled in the art having the benefit of the teachings presented in the present description and the associated drawings. Therefore, it is to be understood that the aspects described herein are not to be limited to the specific examples disclosed.

That which is claimed:

1. A method, comprising establishing an insurance policy on an investment account directly owned by an individual.

2. The method of claim 1, wherein the insurance policy is configured such that a total amount paid to the individual under the insurance policy and the investment account is not limited to a total amount paid by the individual into the investment account.

3. The method of claim 1, wherein the insurance policy is configured such that a total guaranteed amount paid to the individual depends upon a lifetime of the individual.

4. The method of claim 1, wherein the insurance policy is not a guarantee that the individual will receive an amount totaling at least a total amount paid by the individual into the investment account.

5. The method of claim 1, further including transferring money to the individual at each of a plurality of different times, wherein the insurance policy guarantees an amount of each of the monies transferred.

6. The method of claim 5, wherein the distributions may increase in amount over time and the total distributions from the investment and the insurance contract may exceed the individual's original investment.

7. The method of claim 1, wherein the investment account invests only in a single public mutual fund.

8. A method, comprising:
selling an investment product to each of a plurality of investors;
for only a subset of the plurality of investors, establishing a contract with each investor of the subset that guarantees a minimum amount of money to that investor;
for each of the subset of investors, transferring to that investor an amount of money that is at least the minimum amount each of a plurality of times on a periodic basis; and
deducting at least a portion of the transferred amount from a value of the investment product sold to that investor of the subset of investors.

9. The method of claim 8, wherein deducting includes deducting less than the transferred amount from the value of the investment product sold to that investor of the subset of investors.

10. The method of claim 8, wherein for each of the plurality of investors, the investment product consists of a plurality of shares of a single public mutual fund.

11. A method, comprising:
determining whether a value of an investment by an individual investor is zero; and
in response to determining that the value is zero, paying a non-zero amount to the individual investor.

12. The method of claim 11, wherein the investment includes an investment chosen from the following: a mutual fund, a hedge fund, and a stock.

13. The method of claim 11, wherein the investment consists of a single public mutual fund.

14. The method of claim 11, wherein the investment is configured as at least one of the following: a separately-managed account (SMA), a unified managed account (UNMA), and a brokerage account.

15. The method of claim 11, further including determining whether a predetermined total amount has been previously paid to the individual investor, and wherein paying includes paying the non-zero amount in response to determining that the predetermined total amount has not been previously paid.

16. The method of claim 11, further including determining whether a predetermined total amount has been previously paid to the individual investor within a predetermined time period, and wherein paying includes paying the non-zero amount in response to determining that the predetermined total amount has not been previously paid within the predetermined time period.

17. A method, comprising establishing an insurance policy on an investment account, wherein for tax purposes the investment account is treated as if directly owned by an individual.

18. The method of claim 17, wherein the investment account invests in a single publicly-available mutual fund.

19. A method, comprising establishing an insurance policy on an investment, wherein the investment is purchasable separately from the insurance policy.

20. The method of claim 19, wherein the investment includes an investment chosen from one of the following: a mutual fund, a stock, and a hedge fund.

21. A method, comprising:
selling to a first individual investor an investment that includes insurance on the investment; and
selling to a second individual investor the investment without insurance on the investment.

22. The method of claim 21, wherein the investment includes an investment chosen from one of the following: a mutual fund, a stock, and a hedge fund.
